(19) United States
(12) Patent Application Publication
(10) Pub. No.: US 2011/0018993 A1
(43) Pub. Date: Jan. 27, 2011

(54) Ranging apparatus using split complementary color filters

(76) Inventors: Sen Wang, Rochester, NY (US); John N. Border, Walworth, NY (US); Rodney L. Miller, Fairport, NY (US)

Correspondence Address: Raymond L. Owens;Patent Legal Staff, Eastman Kodak Company, 343 State Street, Rochester, NY, 14650-2201, US

(21) Appl. No.: 12/460,828

(22) Filed: Jul. 24, 2009

(51) Int. Cl. H04N 9/47

(52) U.S. Cl. 348/135; 348/E09.033

(57) ABSTRACT

A system for estimating distance to regions in a scene during image capture comprising a lens; a split color filter with complementary colors located at a stop associated with the lens and configured to split an image of a scene received from the lens into two complementary images having complementary colors; a color image sensor configured to simultaneously receive the two complementary images; and a data processing system configured to at least estimate distances to regions in the scene based at least upon an analysis of the received complementary images.

### CROSS-REFERENCE TO RELATED APPLICATIONS

Reference is made to commonly assigned, co-pending U.S. patent application Ser. No. 12/040,274, entitled: “Sensor with Multi-Perspective Image Capture”, by Russell Palum, et al., and U.S. patent application Ser. No. 12/259,348, entitled: “Split Aperture Capture of Rangemap for 3D Imaging”, by John Border.

### FIELD OF THE INVENTION

The present invention relates to a method to estimate distance to regions in a scene during image capture that can be used for capturing still images as well as a series of video images.

### BACKGROUND OF THE INVENTION

Methods for distance estimation to regions in a scene during image capture can be divided into two main approaches: active and passive. Active approaches involve additional energy sources such as illumination sources to determine the distance to objects in the scene. These additional energy sources substantially increase the energy required for capture. In contrast, passive approaches determine the distance to objects in the scene by analysis of changes of viewpoint or focus without using additional illumination sources and as such are more energy efficient.

In a first class of passive distance estimation methods, multiple viewpoints are obtained by capturing multiple images as in stereovision. With these methods, distance is estimated by comparing the relative locations of objects in the multiple images and determining the distance to the objects by triangulation.

In a second class of passive distance acquisition methods, distance is estimated by comparing the focus quality for objects in multiple images that were captured from a single viewpoint using multiple focus settings where the lens is focused at different distances. However, these first and second classes of passive distance estimation methods all require multiple images to be captured and compared to estimate distance thus increasing the computational complexity and increasing the processing time required.

Split color filter systems have been disclosed for use in camera auto-focus systems. In such systems, a split color filter is inserted into the optical path of the lens at the aperture position thereby creating 2 optical paths with different perspectives. The split color filter is constructed so that the filter area is divided into at least two different areas with different colors (typically red and blue) in the different areas. Two images are then formed simultaneously as a first image from light passing through one area of the filter is overlaid on top of a second image from light passing through the other area of the filter. Any defocused regions present in the image have an offset between the two images due to the different perspectives of the two optical paths, which then shows up as color fringes on either side of the object in the image. Movement of the focusing lens reduces or enlarges the color fringes in the image depending on the distance from the defocused region to the focus distance. When the image is well focused, the color fringes disappear. Defocus inside of the focal point causes the fringes to be one color on one side and the other color on the other side of the object in the image. Defocus outside of the focal plane results in the colors of the color fringes being reversed.

A particular split color filter system for autofocus is described by Keiichi in the Japanese Patent Application 2001-174696 where a red and blue split color filter is used. Another autofocus system using a color filter with multiple apertures is presented in United States Patent Publication No. 2006/0092314. In this disclosure, a color filter with two or three different single colors (red, green, and blue) at the aperture creates two or three overlaid images of different colors (red, green, and blue) on the sensor. All of these methods based on split color filters for autofocus introduce an added complexity by altering the color of the images in the different optical paths for each color filter. Therefore, to enable a system using a split color filter arrangement to be used for image capture where color accuracy is important, either the split color filter must be removed during capture of a final image following the auto-focus operation, or this alteration in the color of the image must be corrected during or after the image capture so that an image can be produced with accurate color makeup within the image.

A need exists for a method of estimating distance in a scene from a single image capture without a substantial loss of image quality or a substantial loss of color accuracy.

### SUMMARY OF THE INVENTION

The present invention provides a method and imaging system for estimating distance to regions in a scene during image capture from a single image capture, without additional user requirements and with improved image quality.

In particular, the present invention provides a system for estimating distance to regions in a scene during image capture comprising:

a lens;

a split color filter with complementary colors located at a stop associated with the lens and configured to split an image of a scene received from the lens into two complementary images having complementary colors;

a color image sensor configured to simultaneously receive the two complementary images; and

a data processing system configured at least to estimate distances to regions in the scene based at least upon an analysis of the complementary images.

The present invention provides a way for estimating the distance of objects in the scene from a captured image. The estimated distances to regions in a scene during image capture are presented in the form of a range map. The imaging system of the invention can be used to capture still images or a series of images for a video. The estimated distance information can be used to: improve autofocus; identify edges of objects for object segmentation in the image and for rendering images for 3D display.

In a further embodiment of the invention, image sensors are described with improved color filter arrays that are well suited for use with the split color filter of the invention.

The invention provides many advantages including the following. First, since a high quality-taking lens is used along with a full resolution sensor to capture images, distance estimation is accomplished with improved image quality. Second, by using a split color filter comprised of complementary colors substantially the entire visible spectrum passes through the split color filter and is captured by the image sensor so that sensitivity is increased and color rendition can be improved. Third, the invention can be used for capturing still images or video. Fourth the invention is well suited to compact imaging systems since minimal modifications are required to digital cameras.

### BRIEF DESCRIPTION OF THE DRAWINGS

FIG. 1 is a block diagram of a camera system including a distance estimation system using a split color filter in accordance with an embodiment of the present invention;

FIG. 2 is a schematic diagram of a split color filter imaging system in an embodiment of the invention;

FIG. 3 is a flow chart that illustrates a method for estimating distance to regions in the scene during an image capture in accordance with an embodiment of the invention;

FIG. 4A is a graph of the quantum efficiency for different pixels on a red, green, blue, panchromatic color image sensor;

FIG. 4B is a graph of the light transmission through a split color filter with cyan and red sides;

FIG. 5A illustrates an original captured image in red, green, and blue;

FIG. 5B illustrates an image extracted from the red channel of the image sensor;

FIG. 5C illustrates an image computed from the green and blue channels of the image sensor;

FIG. 5D illustrates a range map computed from the images shown in FIGS. 5B and 5C using the method of the present invention;

FIG. 6 is a graph of the light transmission through a split color filter with yellow and blue sides;

FIG. 7 is a graph of the light transmission through a split color filter with a first side that allows an upper half of the visible spectrum to pass through and a second side that allows a lower half of the visible spectrum to pass through;

FIG. 8A is a schematic diagram of a Bayer color filter array on a portion of an image sensor as practiced in the prior art;

FIG. 8B is a schematic diagram of a color filter array on a portion of an image sensor in an embodiment of the invention; and

FIG. 8C is a schematic diagram of a color filter array on a portion of an image sensor in another embodiment of the invention.

### DETAILED DESCRIPTION OF THE INVENTION

The present invention will be described herein in conjunction with particular embodiments of image capture devices, digital cameras, lenses and image sensors. It should be understood, however, that these illustrative arrangements are presented by way of example only, and should not be viewed as limiting the scope of the invention in any way. Those skilled in the art will recognize that the disclosed arrangements can be adapted in a straightforward manner for use with a wide variety of other types of image capture devices, digital cameras, lenses and image sensors.

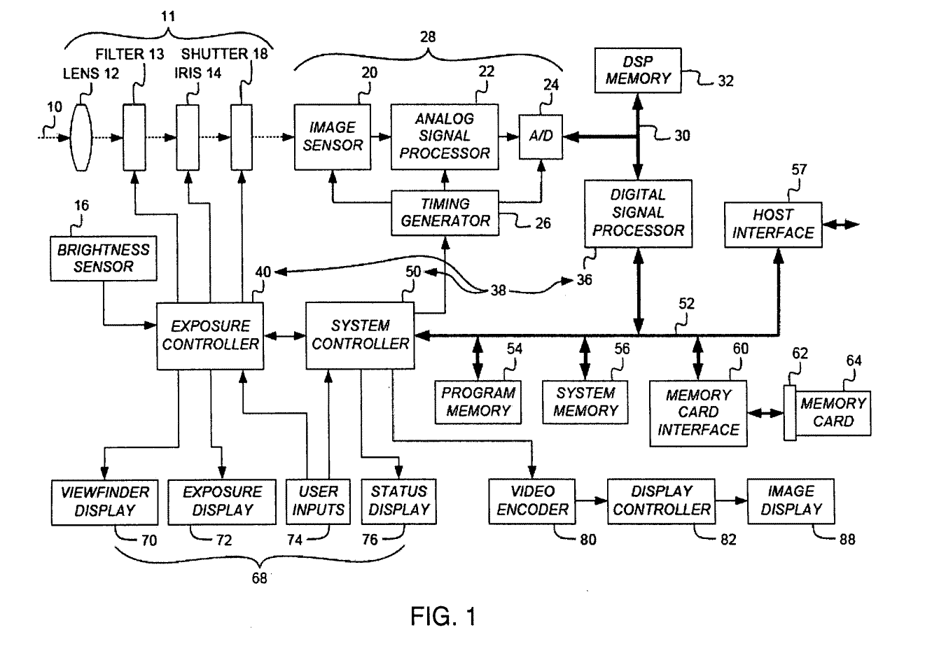

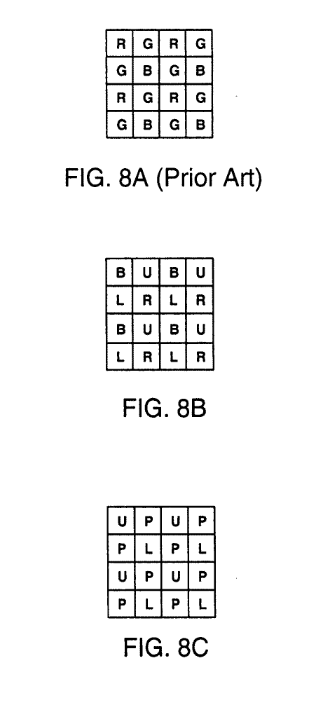

Turning now to FIG. 1, a block diagram of an image capture device, shown as a digital camera, embodying the present invention is shown. Although a digital camera will now be explained, the present invention is clearly applicable to other types of image capture devices. In the disclosed digital camera, incoming light 10 from the subject scene is input to an imaging stage 11, where the light is focused by lens 12 to form an image on solid state image sensor 20. Image sensor 20 converts the incident light to an electrical signal for each picture element (pixel). The image sensor 20 of the preferred embodiment is a charge coupled device (CCD) type or an active pixel sensor (APS) type (APS devices are often referred to as CMOS sensors because of the ability to fabricate them in a Complementary Metal Oxide Semiconductor process). Pixels on the image sensor 20 have color filter arrays (CFAs) applied over the pixels so that each pixel senses a portion of the imaging spectrum. Examples of the CFA patterns of pixels are shown in FIGS. 8A, 8B and 8C although other patterns are used within the spirit of the present invention.

The light passes through the lens 12 and the filter 13 before being sensed by the image sensor 20. Optionally, the light passes through a controllable iris 14 and a mechanical shutter 18. The filter 13 of the invention comprises a split color filter as will subsequently be described in detail along with an optional neutral density (ND) filter for imaging brightly lit scenes. The exposure controller block 40 responds to the amount of light available in the scene as metered by the brightness sensor block 16 and regulates the operation of the filter 13, the iris 14, the shutter 18 and the integration time of the image sensor 20 to control the brightness of the image as sensed by the image sensor 20.

This description of a particular camera configuration will be familiar to one skilled in the art, and it will be obvious that many variations and additional features are present. For example, an autofocus system can be added, or the lenses can be detachable and interchangeable. It will be understood that the present invention is applied to any type of digital camera, where similar functionality is provided by alternative components. For example, the digital camera can be a relatively simple “point-and-shoot” digital camera, where the shutter 18 is a simple movable blade shutter, or the digital camera can be a digital single lens reflex camera where the shutter 18 is a more complicated focal plane shutter arrangement. The present invention can also be practiced on imaging components included in simple camera devices such as mobile phones and automotive vehicles which can be operated without controllable irises 14 and without mechanical shutters 18. The lens 12 of the invention can be a fixed focal length lens or a zoom lens.

The analog signal from image sensor 20 is processed by analog signal processor 22 and applied to analog to digital (A/D) converter 24. Timing generator 26 produces various clocking signals to select rows and pixels and synchronizes the operation of analog signal processor 22 and A/D converter 24. The image sensor stage 28 includes the image sensor 20, the analog signal processor 22, the A/D converter 24, and the timing generator 26. The components of image sensor stage 28 can be separately fabricated integrated circuits, or they can be fabricated as a single integrated circuit as is commonly done with CMOS image sensors. The resulting stream of digital pixel values from A/D converter 24 is stored in digital signal processor (DSP) memory 32 associated with digital signal processor (DSP) 36.

Digital signal processor 36 is one of three processors or controllers in this embodiment, in addition to system controller 50 and exposure controller 40. Although this partitioning of camera functional control among multiple controllers and processors is typical, these controllers or processors can be combined in various ways without affecting the functional operation of the camera and the application of the present invention. These controllers or processors can comprise one or more digital signal processor devices, microcontrollers, programmable logic devices, or other digital logic circuits. Although a combination of such controllers or processors has been described, it should be apparent that one controller or processor can be designated to perform all of the needed functions. All of these variations can perform the same function and fall within the scope of this invention, and the term “processing stage” will be used as needed to encompass all of this functionality within one phrase, for example, as in processing stage 38 in FIG. 1.

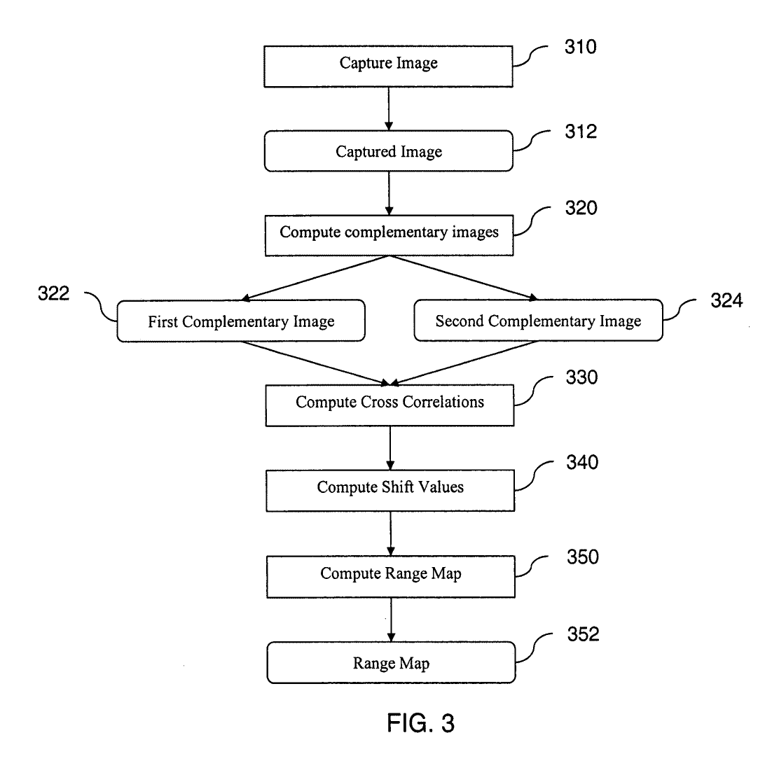

In the illustrated embodiment, DSP 36 manipulates the digital image data in the DSP memory 32 according to a software program permanently stored in program memory 54 and copied to memory 32 for execution during image capture. DSP 36 can be used to execute the software necessary for practicing the image processing of the invention as will be described with reference to FIG. 3. DSP memory 32 includes any type of random access memory, such as SDRAM. A bus 30 comprising a pathway for address and data signals connects DSP 36 to its related DSP memory 32, A/D converter 24 and other related devices.

System controller 50 controls the overall operation of the camera based on a software program stored in program memory 54, which can include Flash EEPROM or other nonvolatile memory. This memory can also be used to store image sensor calibration data, user setting selections and other data which must be preserved when the camera is turned off. System controller 50 controls the sequence of image capture by directing exposure controller 40 to operate the lens 12, filter 13, iris 14, and shutter 18 as previously described, directing the timing generator 26 to operate the image sensor 20 and associated elements, and directing DSP 36 to process the captured image data. After an image is captured and processed, the final image file stored in DSP memory 32 is transferred to a host computer via host interface 57, stored on a removable memory card 64 or other storage device, and displayed for the user on image display 88.

A bus 52 includes a pathway for address, data and control signals, and connects system controller 50 to DSP 36, program memory 54, system memory 56, host interface 57, memory card interface 60 and other related devices. Host interface 57 provides a high speed connection to a personal computer (PC) or other host computer for transfer of image data for display, storage, manipulation or printing. This interface can be an IEEE1394 or USB2.0 serial interface or any other suitable digital interface. Memory card 64 is typically a Compact Flash (CF) card inserted into socket 62 and connected to the system controller 50 via memory card interface 60. Other types of storage that are utilized include without limitation PC-Cards, MultiMedia Cards (MMC), or Secure Digital (SD) cards.

Processed images are copied to a display buffer in system memory 56 and continuously read out via video encoder 80 to produce a video signal. This signal is output directly from the camera for display on an external monitor, or processed by display controller 82 and presented on image display 88. This display is typically an active matrix color liquid crystal display (LCD), although other types of displays are used as well.

The user interface 68, including all or any combination of viewfinder display 70, exposure display 72, status display 76 and image display 88, and user inputs 74, is controlled by a combination of software programs executed on exposure controller 40 and system controller 50. User inputs 74 typically include some combination of buttons, rocker switches, joysticks, rotary dials or touch screens. Exposure controller 40 operates light metering, exposure mode, autofocus and other exposure functions. The system controller 50 manages the graphical user interface (GUI) presented on one or more of the displays, e.g., on image display 88. The GUI typically includes menus for making various option selections and review modes for examining captured images.

Exposure controller 40 accepts user inputs selecting exposure mode, lens aperture, exposure time (shutter speed), and exposure index or ISO speed rating and directs the lens and shutter accordingly for subsequent captures. Brightness sensor 16 is employed to measure the brightness of the scene and provide an exposure meter function for the user to refer to when manually setting the ISO speed rating, aperture and shutter speed. In this case, as the user changes one or more settings, the light meter indicator presented on viewfinder display 70 tells the user to what degree the image will be over or underexposed. In an automatic exposure mode, the user changes one setting and the exposure controller 40 automatically alters another setting to maintain correct exposure, e.g., for a given ISO speed rating when the user reduces the lens aperture the exposure controller 40 automatically increases the exposure time to maintain the same overall exposure.

The ISO speed rating is an important attribute of a digital still camera. The exposure time, the lens aperture, the lens transmittance, the level and spectral distribution of the scene illumination, and the scene reflectance determine the exposure level of a digital still camera. When an image from a digital still camera is obtained using an insufficient exposure, proper tone reproduction can generally be maintained by increasing the electronic or digital gain, but the image will contain an unacceptable amount of noise. As the exposure is increased, the gain is decreased, and therefore the image noise can normally be reduced to an acceptable level. If the exposure is increased excessively, the resulting signal in bright areas of the image can exceed the maximum signal level capacity of the image sensor or camera signal processing. This can cause image highlights to be clipped to form a uniformly bright area, or to bloom into surrounding areas of the image. It is important to guide the user in setting proper exposures. An ISO speed rating is intended to serve as such a guide. In order to be easily understood by photographers, the ISO speed rating for a digital still camera should directly relate to the ISO speed rating for photographic film cameras. For example, if a digital still camera has an ISO speed rating of ISO 200, then the same exposure time and aperture should be appropriate for an ISO 200 rated film/process system.

The ISO speed ratings are intended to harmonize with film ISO speed ratings. However, there are differences between electronic and film-based imaging systems that preclude exact equivalency. Digital still cameras can include variable gain, and can provide digital processing after the image data has been captured, enabling tone reproduction to be achieved over a range of camera exposures. It is therefore possible for digital still cameras to have a range of speed ratings. This range is defined as the ISO speed latitude. To prevent confusion, a single value is designated as the inherent ISO speed rating, with the ISO speed latitude upper and lower limits indicating the speed range, that is, a range including effective speed ratings that differ from the inherent ISO speed rating. With this in mind, the inherent ISO speed is a numerical value calculated from the exposure provided at the focal plane of a digital still camera to produce specified camera output signal characteristics. The inherent speed is usually the exposure index value that produces peak image quality for a given camera system for normal scenes, where the exposure index is a numerical value that is inversely proportional to the exposure provided to the image sensor.

The foregoing description of a digital camera will be familiar to one skilled in the art. It will be obvious that there are many variations of this embodiment that are possible and are selected to reduce the cost, add features or improve the performance of the camera.

The image sensor 20 shown in FIG. 1 typically includes a two-dimensional array of light sensitive pixels fabricated on a silicon substrate that provides a way of converting incoming light at each pixel into an electrical signal that is measured. As the sensor is exposed to light, free electrons are generated and captured within the electronic structure at each pixel. Capturing these free electrons for some period of time and then measuring the number of electrons captured, or measuring the rate at which free electrons are generated measures the light level at each pixel. In the former case, accumulated charge is shifted out of the array of pixels to a charge to voltage measurement circuit as in a charge coupled device (CCD), or the area close to each pixel can contain elements of a charge to voltage measurement circuit as in an active pixel sensor (APS or CMOS sensor).

Whenever general reference is made to an image sensor in the following description, it is understood to be representative of the image sensor 20 from FIG. 1. It is further understood that all examples and their equivalents of image sensor architectures and pixel patterns of the present invention disclosed in this specification can be used for image sensor 20.

In the context of an image sensor, a pixel (a contraction of “picture element”) refers to a discrete light sensing area and charge shifting or charge measurement circuitry associated with the light sensing area. In the context of a digital color image, the term pixel commonly refers to a particular location in the image having associated color values.

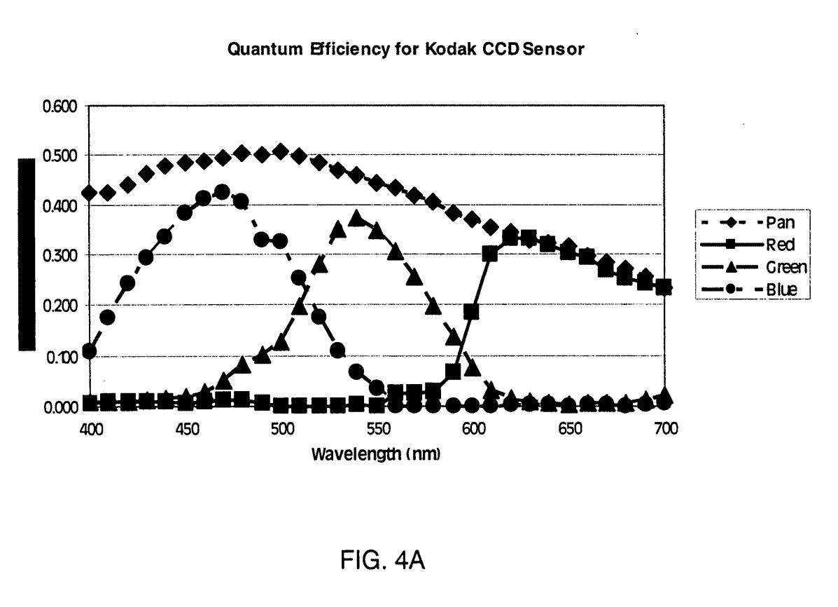

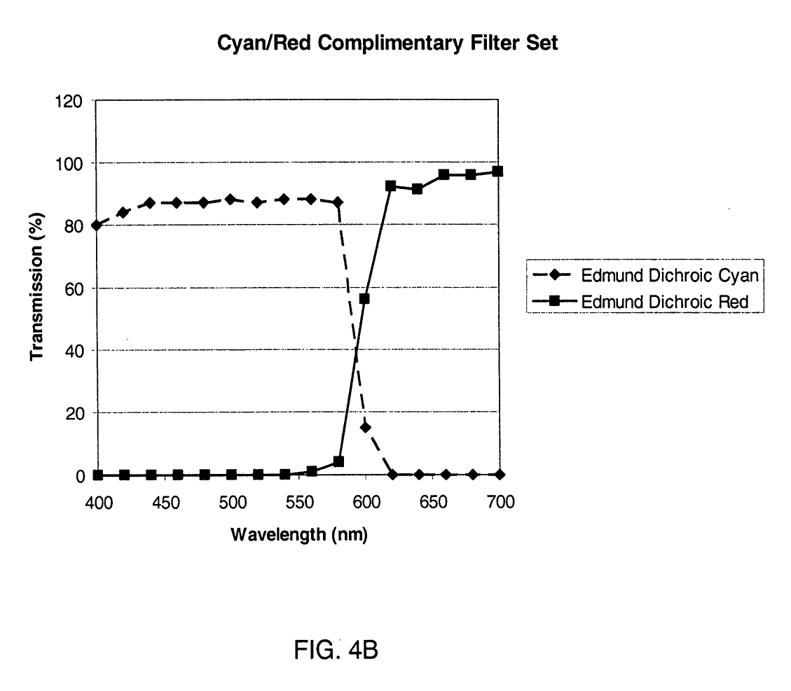

In order to produce a color image, the array of pixels in an image sensor typically has a pattern of color filters placed over them. FIG. 8A shows a pattern of red (R), green (G), and blue (B) color filters that is commonly used in the prior art. This particular pattern is commonly known as a Bayer color filter array (CFA) after its inventor Bryce Bayer as disclosed in U.S. Pat. No. 3,971,065. Each pixel in the image sensor has a particular color photoresponse. In this case, the pixels have a predominant sensitivity to red, green or blue light. Typical red, green and blue photoresponses for a color image sensor are shown in FIG. 4A.

Other useful varieties of image sensors include pixels having color photoresponses with a predominant sensitivity to magenta, yellow, or cyan light. In each case, the particular color photoresponse has high sensitivity to certain portions of the visible spectrum, while simultaneously having low sensitivity to other portions of the visible spectrum. The term color pixel will refer to a pixel having a color photoresponse.

The set of color photoresponses selected for use in an image sensor usually has three colors, as shown in the Bayer CFA shown in FIG. 8A, but it can also include four or more colors. Some image sensors include panchromatic pixels having a panchromatic photoresponse with high sensitivity across the entire visible spectrum as shown in FIG. 4A. The term panchromatic pixel will refer to a pixel having a panchromatic photoresponse. Panchromatic pixels generally have a wider spectral sensitivity than color pixels, and therefore will have a higher overall sensitivity.

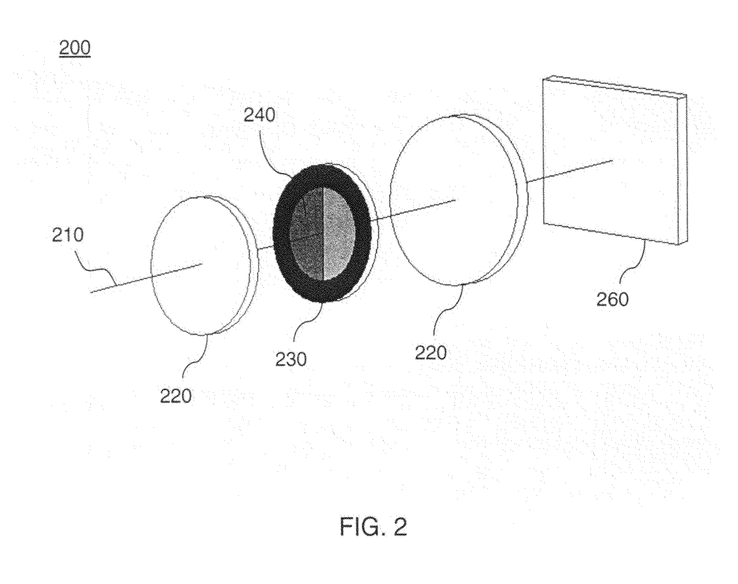

A schematic diagram of a split color filter imaging system 200 is shown in FIG. 2. The split color filter imaging system 200 is comprised of one or more lenses in a lens assembly 220, a split color filter 240, an aperture stop 230 and an image sensor 260. The lens assembly 220, the split color filter 240, the aperture stop 230 and the image sensor 260 share a common optical axis 210. In a preferred embodiment of the present invention, the split color filter 240 is located at a stop associated with the lens assembly 220. The lens assembly 220 can be a fixed focal length lens or a variable focal length (zoom) lens. The split color filter 240 is comprised of two color filters, which each occupy approximately half of the aperture area. The two color filters each filter different portions of the electromagnetic spectrum received by the image sensor 260. Typically the division between the two filters in the split color filter would be arranged vertically but other configurations can be used within the scope of the invention. In a preferred embodiment of the present invention, the image sensor 260 includes a color filter array comprising colors that match the complementary colors of the split color filter 240. Each of the two color filters of the split color filter 240 provide an image to the image sensor 260 within the portion of the imaging spectrum that passes through the respective half of the split color filter 240. Since the respective halves of the split color filter 240 are offset from each other, the images provided by the respective halves of the split color filter 240 have different perspectives forming a stereo image pair wherein the perspectives of the images are separated by approximately 0.4× the diameter of the aperture of the lens. Because the two images from the respective halves of the split aperture device 240 are provided to the image sensor 260 simultaneously, the colors sensed by the image sensor are the combination of the two images in regions where the two images are matched. However, in regions where the different perspectives in the two images provide different image information, the colors in those regions are not aligned and as such the two images will be offset from each other providing colored fringes around objects in the image. It is these image offsets that provide a method for estimating the distance to objects in a scene from the image as sensed by the image sensor 260. This distance information also can be further used to automatically focus an image of the scene.

FIG. 3 illustrates a method for estimating distance of objects in a scene from an image captured in an image capture device using a split color filter imaging system as shown in FIG. 2 in accordance with an embodiment of the present invention. The estimated distance to objects in the scene is presented in the form of a range map. For illustrative purposes only, and not to be limiting thereof, the method shown in FIG. 3 is discussed in the context of the system embodiment in FIG. 1. In capture image step 310, the capture button is pushed by the operator to initiate capture of a captured image 312 from image sensor 20. In a preferred embodiment of the present invention, the captured image 312 has been processed using a CFA interpolation algorithm so that color values for each color channel are available at each pixel location. Alternatively, the method of the present invention can be applied directly to the pixel values in the captured CFA image. However, in this case, it will be necessary to account for the fact that the pixels in each of the color channels are not aligned.

In compute complementary images step 320, the captured image 312 is split into a first complementary image 322 and a second complementary image 324 corresponding to the colors of the split color filter 240 (FIG. 2), such as for example red and cyan. The first and second complementary images 322 and 324 can be still images or alternatively can be image frames extracted from a video sequence.

When the color channels of the image sensor 260 do not match the colors of the split color filter 240, the first and second complementary images 322 and 324 can be computed by appropriate combinations of the color channels in the captured image 312 to form a synthetic color channel. For example, consider the case where the image sensor 260 has pixels with red green and blue photoresponses and the split color filter 240 has red and cyan filters. In this case, the red pixel values in the captured image 312 can be used directly to form the first complementary image 322 corresponding to the red color filter. However, since the image sensor 260 does not have pixels with a cyan spectral response, it is necessary to combine the green and blue pixel values in the captured image 312 to form a synthetic cyan color channel corresponding to the cyan color filter to use for the second complementary image 322. In a preferred embodiment of the present invention, the synthetic cyan pixel values C are computed according to the following equation:

C=w₁·G+w₂·B

where G and B are the green and blue channel pixel values of the captured image 312, respectively, and w₁ and w₂ are two weight parameters. The values of the two weight parameters w₁ and w₂ can be determined to provide the best match between the spectral response of the cyan filter and the effective spectral response of the synthetic cyan color channel.

Next, compute cross correlations step 330 is used to cross correlate the first complementary image 322 and the second complementary image 324. In this step, normalized cross-correlation functions are determined for each image pixel. The normalized cross-correlation functions are computed using image blocks of size k×1 pixels. The image blocks are translated around each pixel in an area of size m×n pixels to determine normalized cross-correlation functions of size m×n for each image pixel.

Next, compute shift values step 340 determines a shift value for each image pixel by determining the highest correlation value in the normalized cross-correlation function for that image pixel. Finally, compute range map step 350 is used to determine a range map 352 representing a range value for each image pixel. The range value can be calculated from the shift value according to the following equation:

R=f(sv)

where sv is the shift value, and function f( ) is a range calibration function which relates the shift values to corresponding range values. In a preferred embodiment of the present invention the range calibration function is determined experimentally by photographing objects at known range distances and determining the corresponding shift values. A smooth function can then be fit to the measured data to describe the relationship between the range and shift values. In one embodiment of the present invention, the range calibration function is stored as a look-up table which stores range values for a series of shift values. The look-up table can be accessed directly by rounding the shift value to the closest look-up table entry, or alternatively well-known interpolation methods can be used to interpolate between the look-up table entries. In an alternate embodiment of the present invention the range calibration function can be determined theoretically from well-known parallax equations that can be used to compute the range from the shift value together with a series of parameters describing the optical system.

In a preferred embodiment of the present invention, the range map 352 is computed after a de-noise algorithm, such as a graph cut algorithm or a Gaussian smooth algorithm, has been applied to the captured image 312 in order to reduce variability in the estimated range values.

FIG. 4B shows a graph of transmission vs. wavelength for the two sides of a split color filter 240 as an example embodiment of the invention. For this example, one half of the split color filter 240 allows cyan light to pass while the other half of the split color filter 240 allows red light to pass. In this way, the split color filter 240 provides two optical paths comprised of cyan and red light respectively wherein the two optical paths are separated by a distance due to the different locations of their respective halves in the aperture 230 such that different perspectives are provided by the two optical paths. By providing two optical paths with two different split color filter halves, areas in the captured image where the different perspectives of the two optical paths produce regions in the image where the images from the two optical paths do not overlap so that range information can be obtained.

In a preferred embodiment of the present invention, the halves of the split color filter are chosen to provide complementary color filtering. Complementary color filtering comprises two color filters which together allow substantially all the light in the visible spectrum to pass through the combined two halves of the split color filter. For the case shown in FIG. 4B, one half of the split color filter 240 allows light below approximately 600 nm to pass through the filter to the image sensor 260 while the other half of the split color filter allows light approximately above 600 nm to pass through the filter to the image sensor 260. Using complementary color filters in the split color filter, allows for clear separation of the two images while maximizing the available visible light that is allowed to pass through to the image sensor, thereby increasing the sensitivity of the imaging system. This case of cyan and red color filters in the split color filter is well suited for use with a Bayer type imaging sensor since the pixels are sensitive to red, green and blue so that the red pixels receive the image from the red filter and the green and blue pixels receive the image from the cyan filter.

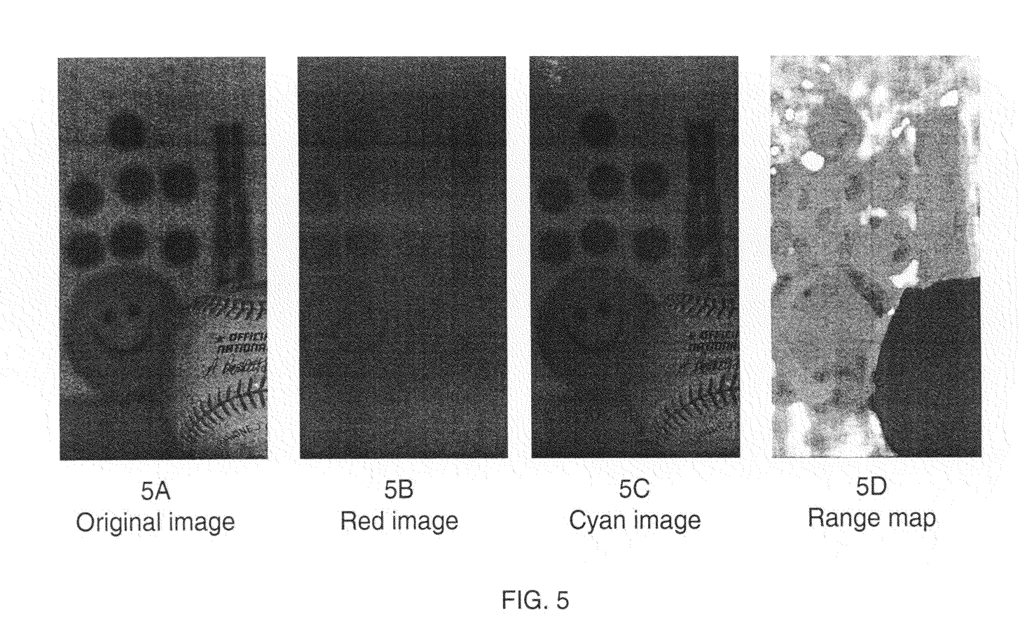

FIGS. 5A-5D show a series of images that illustrate the method of one embodiment of the invention using the method shown in FIG. 3 and described previously, with a split color filter imaging system as shown in FIG. 2 with complementary color filters as shown in FIG. 4B. FIG. SA shows an example image as captured in capture image step 310 by a split color filter imaging system wherein the split color filter includes red and cyan filters and a Bayer imaging sensor. FIGS. 5B and 5C illustrate the first complementary image 322 and the second complementary image 324, respectively, produced in compute complementary images step 320. FIG. 5B illustrates a red image produced from the red pixels on the image sensor and as such containing the red portion of the image shown in FIG. 5A. FIG. 5C illustrates a cyan image computed from the green and blue pixels on the image sensor and as such containing the green and blue portions of the image shown in FIG. 5A. FIG. 5D illustrates the computed range map 352 as produced in compute range map step 350, where darker colors indicate objects which are located nearer to the image capture device than light colored objects which are located farther from the image capture device.

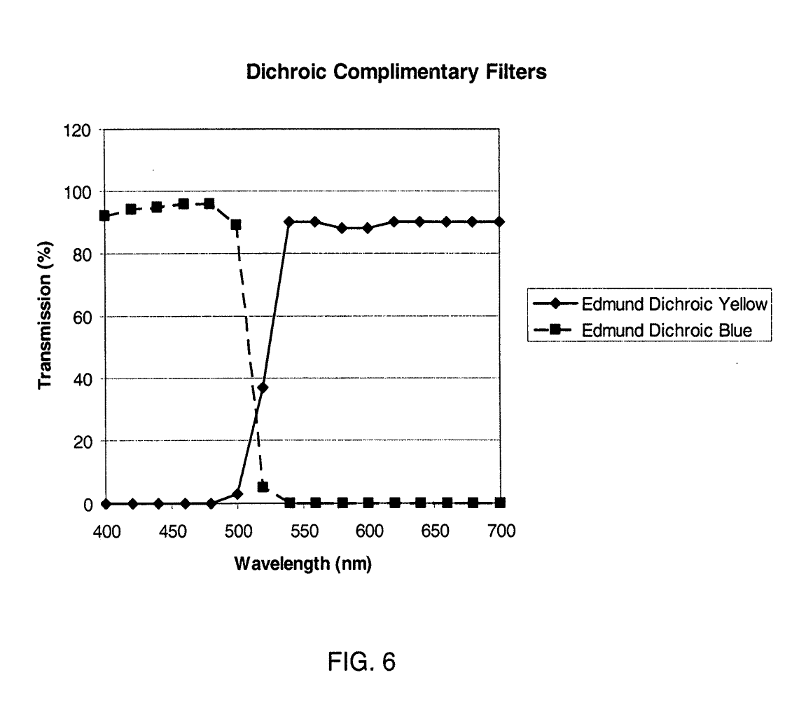

FIG. 6 shows spectral transmittances for split color filter 240 according to an alternate embodiment of the invention. In this case, the split color filter 240 includes blue and yellow filters. (Filters of the type shown can be obtained at Edmund Optics as dichroic filters that provide blue and yellow light respectively.) The yellow filter transmits both the red and green light. This embodiment is also suited to image sensors which have red, green and blue pixels such as for example the Bayer color filter array shown in FIG. 8A or others which include red, green and blue pixels or red, green, blue and panchromatic pixels. In this case, the first complementary image 322 is based on the blue pixels of the image sensor while the second complementary image 324 is computed from the green and red pixels of the image sensor, and range map 352 is produced by cross-correlating the blue image with the yellow image.

In yet another embodiment of the present invention, after the range map has been produced, a conventional full color image or video is generated. The split color filter still remains in the optical path during the capture of the full color image. To form a sharp full color image, the two overlaid images must be aligned with each other. Alignment of the two images is accomplished by shifting the images relative to each other based on the shift values as determined in compute shift values step 340. The pixel values of the two images are then combined to form a combined image. For the case of embodiments which include sensors with red, green and blue pixels, a full color image can be produced by interpolating adjacent pixel values to provide color values for each pixel as is well known in the art.

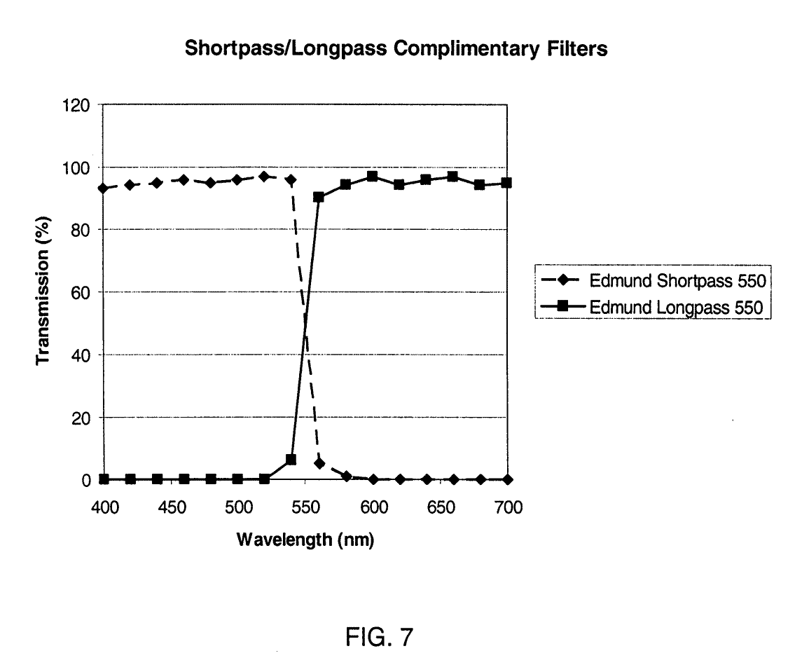

FIG. 7 shows spectral transmittances for split color filter 240 according to yet another embodiment of the present invention. In this split color filter 240, the colors in the filter divide the visible spectrum into substantially even upper and lower halves of the visible spectrum. By dividing the spectrum into substantially even upper and lower halves of the visible spectrum, a balanced sensitivity of visible light in the scene is provided to the image sensor. Color filters of the type shown in FIG. 7 can be obtained from Edmund Optics as shortpass and long pass filters respectively that allow light to pass through the filter half below or above 550 nm respectively. Color filter array patterns that are suited for use with a split color filter which has the spectrum response shown in FIG. 7 are shown in FIGS. 8B and 8C. In these color filter arrays, pixels are included which respond to the upper and lower halves of the visible spectrum. In these figures, pixels that respond to the upper half of the visible spectrum as denoted by U while pixels which respond to the lower half of the visible spectrum are denoted by L. In the case of an image captured with an image sensor as shown in FIG. 8B, the first complementary image 322 is produced from the B and L pixels while the second complementary image 324 is produced from the R and U pixels. The range map 352 is then produced by cross-correlating the first complementary image 322 to the second complementary image 324.

Color information for the full color image is provided by subtracting narrow spectral pixel values from wide spectral pixel values to produce red, green and blue pixel values. To form a sharp full color image from the image captured with a split color filter as shown in FIG. 7, the two images produced from the B and L pixels and the R and U pixels must be aligned based on the shift values as described previously. Then, pixel values are computed for the L and U pixels by subtracting the B and R values from neighboring pixels to form lower green and upper green pixel values. A full color image can then be produced by interpolating the pixel values from the B, lower green, upper green and R pixel values for their respective pixels as is well known in the art.

The invention has been described in detail with particular reference to certain preferred embodiments thereof, but it will be understood that variations and modifications can be effected within the spirit and scope of the invention.

### PARTS LIST

10 Incoming light
11 Imaging stage
12 Lens
13 Filter
14 Iris
16 Brightness sensor
18 Shutter
20 Image sensor
22 Analog signal processor
24 Analog to digital converter
26 Timing generator
28 Image sensor stage
30 Bus
32 Digital signal processor memory
36 Digital signal processor
38 Processing stage
40 Exposure controller
50 System controller
52 Bus
54 Program memory
56 System memory
57 Host interface
60 Memory card interface
62 Socket
64 Memory card
68 User interface
70 Viewfinder display
72 Exposure display
74 User inputs
76 Status display
80 Video encoder
82 Display controller
88 Image display
200 Split color filter imaging system
210 Optical axis
220 Lens assembly
230 Aperture stop
240 Split color filter
260 Image sensor
310 Capture image step
312 Captured image
320 Compute complementary images step
322 First complementary image
324 Second complementary image
330 Computer cross correlations step
340 Compute shift values step
350 Compute range map step
352 Range map

What is claimed is:

1. A system for estimating distance to regions in a scene during image capture comprising:
a lens;
a split color filter with complementary colors located at a stop associated with the lens and configured to split an image of a scene received from the lens into two complementary images having complementary colors;
a color image sensor configured to simultaneously receive the two complementary images; and
a data processing system configured to at least estimate distances to regions in the scene based at least upon an analysis of the received complementary images.

2. The system of claim 1, wherein the analysis of the complementary images includes generating cross correlation information from the complementary images.

3. The system of claim 2, wherein the analysis of the complementary images includes generating shift values from the cross correlation information.

4. The system of claim 1, wherein the estimated distances are presented in the form of a range map.

5. The system of claim 1, wherein the complementary colors are red and cyan.

6. The system of claim 1, wherein the complementary colors are blue and yellow.

7. The system of claim 1, wherein the complementary colors are upper and lower halves of a visible spectrum.

8. The system of claim 1, wherein the color image sensor includes a color filter array, the color filter array including colors that match, or can be combined to match, the complementary colors of the split color filter.

9. The system of claim 8, wherein the image sensor comprises a color filter array including red, green, and blue pixels.

10. The system of claim 8, wherein the image sensor comprises a color filter array including red, green, blue, and panchromatic pixels.

11. The system of claim 8, wherein the image sensor comprises a color filter array including red, blue, upper half of a visible spectrum, and lower half of the visible spectrum pixels.

12. The system of claim 8, wherein the image sensor comprises a color filter array including upper half of the visible spectrum, lower half of the visible spectrum, and panchromatic pixels.

13. The system of claim 1 wherein the lens is a fixed focal length lens or a zoom lens.

14. The system of claim 1, wherein the complementary images are still images.

15. The system of claim 1, wherein the complementary images are frames in a sequence of video images.

16. The system of claim 1, wherein the data processing system is further configured to automatically focus the lens based at least upon an analysis of the estimated distances.

17. The system of claim 1, wherein the data processing system is further configured to generate a full color image or full color video sequence based at least upon an analysis of the complementary images.

18. The system of claim 17, wherein the split color filter remains in the optical path during the capture of the full color image.

19. A method of estimating distance to regions in a scene during image capture, comprising:
capturing an image through a lens and a split color filter having complementary colors, the split color filter being located at a stop associated with the lens, the split color filter splitting the image into two complementary images having complementary colors; and
estimating distances to regions in the scene based at least upon extracting the two complementary images from the captured image and performing an analysis of the two complementary images.

20. The method of claim 19, wherein the analysis of the complementary images includes generating cross correlation information from the two complementary images.

21. The method of claim 20, wherein the analysis of the complementary images includes generating shift values from the cross correlation information.

22. The method of claim 19, wherein the estimated distances are in the form of a range map.

23. The method of claim 19, further comprising generating a full color image based at least upon an analysis of the complementary images.

24. The method of claim 19, wherein one of the complementary images is formed by combining pixels captured with different photoresponses, including combining green and blue pixels to form cyan pixels, or green and red pixels to form yellow pixels.

25. The method of claim 19, further comprising an image sensor including a color filter array, the color filter array including colors that match, or can be combined to match, the complementary colors of the split color filter.

26. The method of claim 25, wherein the image sensor includes a color filter array comprising red, blue, upper half of a visible spectrum, and lower half of the visible spectrum pixels.

27. The method of claim 26, wherein color information to produce a full color image is provided by subtracting narrow spectral pixel values from wide spectral pixel values to produce red, green, and blue pixel values.

28. The method of claim 20, wherein the cross correlation information is normalized.

29. The method of claim 22, wherein the range map is computed from a shift value determined for each pixel, and wherein range values in the range map are determined relative to a predetermined reference location.

30. The method of claim 19, wherein the analysis of the complementary images includes the step of applying a de-noise algorithm.

31. The method of claim 30 wherein the de-noise algorithm is a graph cut algorithm or a Gaussian smooth algorithm.
